(19) United States
(12) Patent Application Publication
(10) Pub. No.: US 2013/0179636 A1
(43) Pub. Date: Jul. 11, 2013

(54) MANAGEMENT APPARATUS AND MANAGEMENT METHOD OF COMPUTER SYSTEM

(71) Applicants: Akira Shirasu, Yokohama (JP); Yasufumi Uchiyama, Yokohama (JP)

(72) Inventors: Akira Shirasu, Yokohama (JP); Yasufumi Uchiyama, Yokohama (JP)

(73) Assignee: HITACHI, LTD., Tokyo (JP)

(21) Appl. No.: 13/393,468

(22) PCT Filed: Jan. 5, 2012
(86) PCT No.: PCT/JP2012/050061

§ 371 Date: Feb. 29, 2012

(51) Int. Cl. G06F 12/08

(52) U.S. Cl. 711/117; 711/E12.016

(57) ABSTRACT

To improve the performance of a computer system and user-friendliness for an administrator. A storage system 30 provides a virtual volume 32 to a host computer 10. Based on an access frequency, the storage system rearranges data in a logical storage region of the virtual volume in any of a plurality of storage tiers. A management computer monitors statuses of resources (the host computer, a switch, a controller of the storage system) related to the virtual volume, and determines to permit or inhibit the execution of a rearrangement process on the virtual volume based on the monitoring result. The management computer notifies the storage system of the details of this determination.

### TECHNICAL FIELD

The present invention relates to a management apparatus and a management method of a computer system.

### BACKGROUND ART

There have been known technologies where hierarchized storages are utilized in units of pages in order to facilitate more efficient storage management. In a first conventional technology, a plurality of storage tiers of different performances are defined within a logical pool, and storage regions within the pool are allocated to virtual logical volumes each time when a host computer uses the virtual logical volumes. In the first conventional technology, pages that are frequently accessed by the host computer are arranged in storage tiers of relatively high performance, and pages that are less frequently accessed by the host computer are arranged in storage tiers of relatively low performance (Patent Literature 1).

As a second conventional technology, there has been known a technology where an access path between a host computer and a logical volume is switched to an alternative bus path in view of an impact upon another application, when a bottleneck is detected on the access path (Patent Literature 2).

### CITATION LIST

### Patent Literature

[PTL 1]

WO 2011/077489

[PTL 2]

Japanese Patent Application Publication No. 2007-233783

### SUMMARY OF INVENTION

### Technical Problem

The first conventional technology improves the response performance of the storage system by arranging the pages of high access frequencies in the high-performance storage tiers. However, when the access path between the host computer and the logical volume has a bottleneck, arranging the pages of high access frequencies in the high-performance storage tiers might not improve the response performance.

For example, when the utilization of a CPU (Central Processing Unit) of the host computer is high, high-speed data processing cannot be performed even if the host computer accesses the pages arranged in the high-performance storage tiers. Furthermore, when, for example, the CPU utilization of a switch that connects the host computer to the storage system is high, the host computer cannot quickly access the data of the pages arranged in the high-performance storage tiers.

Therefore, there is no point in arranging the data of the pages of the logical volume in the pages within the high-performance storage tiers when the access path to the logical volume has a bottleneck. Consequently, the pages within the high-performance storage tiers cannot be used effectively, and the response performance of the storage system cannot be improved.

On the other hand, the second conventional technology can prevent the generation of a bottleneck by switching the access path to the alternative path. However, in order to switch the normal access path to the alternative path, the configurations of the storage system and the entire computer system including the host computer and the switch need to be changed. This process of switching the access path to the alternative path requires time and effort, increasing the workloads of a user.

Moreover, the user cannot easily determine whether the bottleneck on the access path is only temporary or happens constantly. Especially in a computer system such as a data center that has a mixture of a number of host computers, switches, and storage systems, it is difficult to make such determination.

The present invention was contrived in view of the problems described above, and an object thereof is to provide a management apparatus and a management method of a computer system, which are capable of improving the performance of the computer system. Another object of the present invention is to provide a management apparatus and a management method of a computer system, which are capable of effectively utilizing a storage region of a storage system by inhibiting the execution of a meaningless rearrangement process, and capable of assisting a user in deciding whether to change the compositions of the computer system, by providing the user with information related to inhibition of the rearrangement process.

### Solution to Problem

In order to achieve the object described above, a management apparatus according to the present invention is a management apparatus for managing a computer system including a host computer and a storage system, wherein the storage system includes a virtual logical volume provided to the host computer, and a pool having a plurality of storage tiers, and executes a rearrangement process for associating a plurality of logical storage regions forming the virtual logical volume to storage regions within any of the plurality of storage tiers based on an access frequency of the host computer to each of the logical storage regions, and wherein the management apparatus comprises a resource monitoring part for monitoring a status of a resource related to the virtual logical volume, and a rearrangement availability determination part for determining whether or not the rearrangement process can be executed on the virtual logical volume.

The resource monitoring part is a predetermined resource that exists on a communication path extending from the host computer to the virtual logical volume, and is capable of monitoring statuses of a plurality of predetermined resources including the host computer and the storage system. When the statuses of the plurality of predetermined resources monitored by the resource monitoring part satisfy a predetermined inhibition condition that is configured in advance, the rearrangement availability determination part can determine to inhibit the execution of the rearrangement process on the virtual logical volume. Moreover, the management apparatus may have a rearrangement instruction part for instructing the storage system to execute the rearrangement process based on the determination made by the rearrangement availability determination part.

When the status of at least one of the plurality of predetermined resources satisfies the predetermined inhibition condition for the predetermined resource, the rearrangement availability determination part may determine to inhibit the execution of the rearrangement process on the virtual logical volume.

To allow the rearrangement availability determination part to determine to inhibit the execution of the rearrangement process on the virtual logical volume, each of the logical storage regions of the virtual logical volume can be prohibited from being rearranged in a storage tier higher than a current storage tier out of the storage tiers.

The characteristics of the present invention described above can be combined in various ways outside what is described above. In addition, the present invention can be understood as a computer program. The computer program is installed in a computer by means of a communication medium or a recording medium.

### BRIEF DESCRIPTION OF DRAWINGS

FIG. 1 is a composition explanatory diagram showing the entire composition of a computer system.

FIG. 2 is an explanatory diagram showing a relationship of a virtual volume to a pool and a storage apparatus.

FIG. 3 is an explanatory diagram showing a relationship between computer programs and tables of a management computer.

FIG. 4 shows a composition example of a resource information management table.

FIG. 5 shows a composition example of a network topology management table.

FIG. 6 shows a composition example of a table for managing histories of resource performances.

FIG. 7 shows a composition example of a table for managing warnings.

FIG. 8 shows a composition example of a page management table.

FIG. 9 shows a composition example of a table for managing histories of inhibiting the execution of a rearrangement process.

FIG. 10 is a flowchart showing an overall flow of operations of a management computer.

FIG. 11 is a flowchart showing a threshold value configuration process.

FIG. 12 is a screen example for configuring threshold values.

FIG. 13 is a flowchart of a process for monitoring resources and collecting composition information.

FIG. 14 is a flowchart of a process for determining whether the rearrangement process can be performed or not.

FIG. 15 is a flowchart of a process for instructing a storage system on the execution of the rearrangement process.

FIG. 16 is a flowchart of a warning process.

FIG. 17 shows an example of a warning popup screen.

FIG. 18 shows an example of a screen showing statistics of the inhibited rearrangement process.

FIG. 19 is a flowchart of a process for outputting analysis results.

FIG. 20 shows a screen example showing a list of resources that are the causes the inhibition of the rearrangement process.

FIG. 21 is an explanatory diagram schematically illustrating a relationship between the resources that are the causes of the inhibition of the rearrangement process, and virtual volumes.

FIG. 22 shows an example of a display screen of a network topology including the resources that are the causes the inhibition of the rearrangement process.

### DESCRIPTION OF EMBODIMENTS

Embodiments of the present invention are described hereinafter with reference to the drawings. As will be described hereinafter, the present embodiment monitors statuses of resources related to a virtual logical volume, and determines, based on the results of monitoring, whether or not a rearrangement process can be executed on the virtual logical volume. The present embodiment also manages histories obtained when the execution of the rearrangement process is inhibited, and provides a user with a visualized relationship between a bottleneck on a communication path and the inhibition of the rearrangement process.

Note in the following description that various pieces of information are described using an expression such as “xxx table.” However, various pieces of information may be expressed in the form of a data structure other than a table. In order to explain that the various pieces of information do not depend upon the data structure, “xxx table” can be referred to as “xxx information.”

In the following description, each process is described using a term “program” as the subject. The program is executed by a processor (e.g., a CPU (Central Processing Unit)) in order to execute a defined process by appropriately using a storage resource, such as a memory, and a communication interface apparatus such as a communication port. Thus, the subject of the description of each process may be “processor.” The processor may have dedicated hardware in addition to the CPU. A computer program may be installed from a program source into a computer. The program source may be, for example, a program distribution server or a storage medium.

For example, each of elements such as a pool volume can be identified by an identifier (ID), a number, a name and the like.

An embodiment of the present invention is described hereinafter with reference to the drawings. The present invention is not limited to the embodiment described hereinafter, and various applications corresponding to the ideas of the present invention are included in the technical scope of the present invention. In addition, there may be more than one component, unless otherwise limited.

### EXAMPLE 1

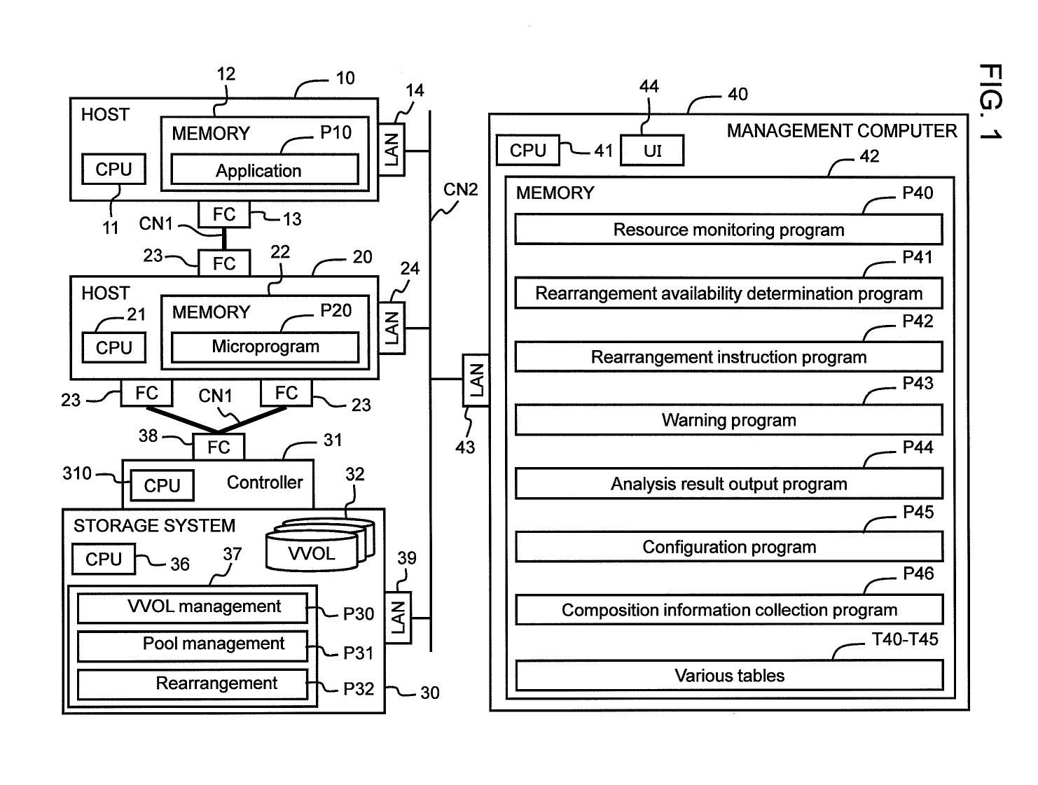

FIG. 1 shows the entire composition of a computer system. A computer system includes, for example, at least one host computer (“host” hereinafter) 10, at least one switch 20, at least one storage system 30, and one management computer 40.

The host 10 and the storage system 30 are connected to each other by the switch 20. The host 10, the switch 20 and the storage system 30 are connected in a two-way communicable manner to one another via a communication network CN1 such as an IP-SAN (Internet Protocol_SAN) or FC-SAN (Fibre Channel-Storage Area Network).

The management computer 40, an example of “management apparatus,” is connected in a two-way communicable manner to the host 10, the switch 20 and the storage system 30 via a management communication network CN2 such as a LAN (Local Area Network).

When using, for example, an iSCSI (internet Small Computer System Interface), the communication networks CN1 and CN2 may be formed into a single LAN.

The host 10 is formed as a computer such as a server computer or a mainframe machine. The host computer 10 has, for example, a microprocessor (CPU) 11, a memory 12, an FC port 13, and a LAN port 14.

In addition to an operating system and the like, which are not shown, an application program (“application” hereinafter) P10 is stored in the memory 12. The CPU 11 performs a predetermined data process by executing the application P10. The FC port 13 is a communication circuit connected to the communication network CN1. The LAN port is a communication circuit connected to the communication network CN2.

The switch 20 manages a communication between the host 10 and the storage system 30. The switch 20 has, for example, a CPU 21, a memory 22, a plurality of FC ports 23, and a LAN port 24. A micro program P20 for controlling operations of the switch 20 is stored in the memory 22.

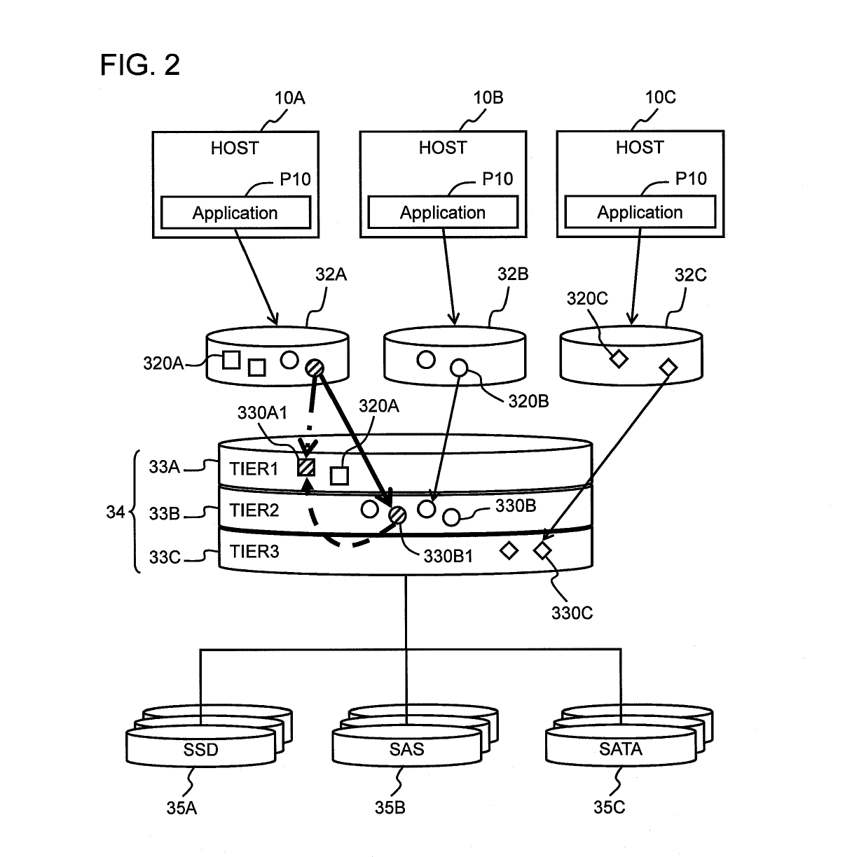

The storage system 30 is an apparatus for providing storage regions to the host 10. The storage system 30 has, for example, an FC controller 31, a virtual volume 32, a plurality of logical volumes 35 (see FIG. 2), a CPU 36, a memory 37, an FC port 38, and a LAN port 39.

For example, a program P30 for managing the virtual volume, a program P31 for managing a pool 34 (see FIG. 2), and a program P32 for performing page rearrangement are stored in the memory 37. The diagram describes the virtual volume as “VVOL.”

The virtual volume management program P30 allocates a physical page 330 (see FIG. 2) of the pool 34 to the virtual volume 32 in response to the access from the host 10. The virtual volume management program P30 manages a correspondence relationship between a logical page 320 (see FIG. 2) forming the virtual volume 32 and the physical page 330 of the pool 34.

The pool management program P31 manages a composition of the pool 34. Based on an access frequency (amount of I/O) to the logical page 320, the rearrangement program P32 determines the physical page 330 for storing data of the logical page 320 therein. As will be described hereinafter, the rearrangement program P32 does not perform a rearrangement process on the virtual volume 32 on which the execution of the rearrangement process is inhibited by the management computer 40.

The FC controller 31 controls a communication between the storage system 30 and the host 10 and the switch 20. The FC controller 31 is connected to the communication network CN1 by the FC port 38.

As with the host 10 and the switch 20, the FC controller 31 is managed as a predetermined resource on a communication path used for accessing the virtual volume 32. A utilization of the FC controller 31 on a CPU 310 is one of the things monitored by the management computer 40.

The management computer 40 has, for example, a CPU 41, a memory 42, a LAN port 43, and a user interface part 44. A plurality of computer programs P40 to P46 and a plurality of management tables T40 to T45 are stored in the memory 42. Each of the programs P40 to P46 and each of the tables T40 to T45 are described hereinafter in detail.

The user interface part 44 has an information output apparatus for outputting information to the user, and an information input apparatus for receiving input from the user. Examples of the information output apparatus include a display apparatus, a printer, and an audio output apparatus. Examples of the information input apparatus include a keyboard switch, a pointing apparatus, a graphics tablet, and an audio input apparatus.

The management computer 40 and the user interface part 44 may be formed separately. For instance, a management terminal for operating the management computer 40 may be provided, and information may be displayed on a display apparatus of this management terminal, or information may be input to the management computer 40 by using a keyboard or the like of the management terminal. This type of a management terminal can be formed as, for example, a personal computer, a cellular phone, or a portable information terminal.

FIG. 2 is an explanatory diagram schematically showing a relationship among the virtual volume 32, the pool 34, and the logical volumes 35.

The storage system 30 can have a plurality of storage apparatuses. Various apparatuses capable of reading data from, for example, hard disk drives, semiconductor memory drives, flash memory apparatuses (SSD: Solid State Drives), and optical disk drives, can be utilized as the storage apparatuses. When using hard disk drives, for example, FC (Fibre Channel) disks, SCSI (Small Computer System Interface) disks, SATA disks, ATA (AT Attachment) disks, SAS (Serial Attached SCSI) disks and the like can be used.

Moreover, various storage apparatuses such as flesh memories, FeRAMs (Ferroelectric Random Access Memory), MRAMs (Magnetoresistive Random Access Memory), phase-change memories (Ovonic Unified Memories), and RRAMs (Resistance RAM: trademark) can be used. In addition, different types of storage apparatuses can be combined, such as a combination of flesh memory apparatuses and hard disk apparatuses.

The plurality of storage apparatuses can be formed into one parity group, and physical storage regions of each storage apparatus can be collected into one redundant storage region. One or a plurality of logical volumes 35A to 35C can be created using this redundant storage region.

The logical volume 35A is generated using a storage region of a relatively high-performance storage apparatus (e.g., SSD). The logical volume 35B is generated using a storage region of a medium-performance storage apparatus (e.g., SAS). The logical volume 35C is generated using a storage region of a low-performance storage apparatus (e.g., SATA). It should be noted that one or a plurality of logical volumes can be created using a storage region of a single storage apparatus. Unless otherwise distinguished, each of the logical volumes 35A to 35C is referred to as “logical volume 35.”

The pool 34 has a plurality of storage tiers 33A, 33B, 33C of different performances. The first storage tier 33A is a tier of the highest performance. The high-performance logical volume 35A is registered in the first storage tier 33A. The medium-performance logical volume 35B is registered in the second storage tier 33B. The low-performance logical volume 35C is registered in the third storage tier 33C.

The virtual volume 32 can be provided in plurality as virtual logical volumes in the storage system 30. In the example shown in FIG. 2, a first virtual volume 32A is used by a first host 10A. A second virtual volume 32B is used by a second host 10B. A third virtual volume 32C is used by a third host 10C. Unless otherwise distinguished, the hosts 10A to 10C are each referred to as “host 10,” and the virtual volumes 32A to 32C are each referred to as “virtual volume 32.”

A logical storage region of the virtual volume 32 is comprised of a plurality of logical pages 320. The physical page 330 is associated with each logical page 320 in response to a write access from the host 10. The physical storage regions of each storage apparatus are separated by a plurality of the physical pages (or segments) 330. Allocating the physical pages 330 to the logical pages 320 can allow data to be written to the logical pages 320.

In the example shown in FIG. 2, relatively a large number of physical pages 330A of the high-performance storage tier 33A are allocated to the virtual volume 32A. Physical pages 330B of the medium-performance storage tier 33B are allocated to the virtual volume 32B. Physical pages 330C of the low-performance storage tier 33C are allocated to the virtual volume 32C.

A brief overview of the page rearrangement is now described. Suppose that data of a logical page 320A1 within the first virtual volume 32A are originally stored in a physical page 330B1 of the second storage tier 33B. When the host 10A frequently accesses this logical page 320A1, the storage system 30 selects, in place of the physical page 330B1, a logical page 330A1 of the first storage tier 33A as a physical page for storing the data of the logical page 320A1 therein. As indicated by a dashed line in the diagram, the storage system 30 copies the data of the logical page 320A1 from the physical page 330B1 to the physical page 330A1. The storage system 30 then stores the association between the logical page 320A1 and the physical page 330A1.

In this manner, the physical pages 330 that have higher performances than the currently allocated physical pages 330 are allocated to the logical pages 320 of high access frequencies. Contrary to this, the physical pages 330 that have lower performances than the currently allocated physical pages 330 are allocated to the logical pages 320 of low access frequencies. When data of the logical pages 320 of high access frequencies are already arranged in the highest tier 33A, the data of the logical pages 320 remain in the tier 33A even when the frequencies of access to the logical pages 320 increase. When the data of the logical pages 320 of low access frequencies are arranged in the lowest tier 33C, the data of the logical pages 320 remain in the tier 33C even when the frequencies of accesses to the logical pages 320 decrease.

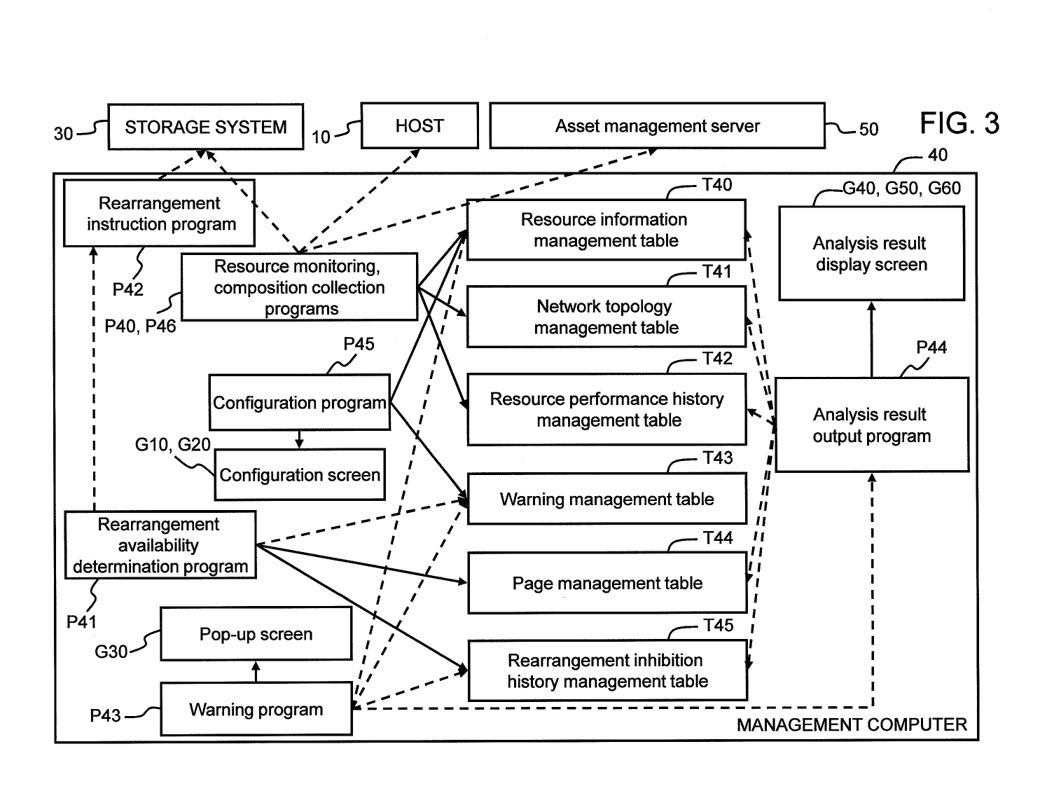

FIG. 3 is an explanatory diagram showing a relationship between the computer programs P40 to P46 and the management tables T40 to T45 that are provided in the management computer 40. Solid lines shown in FIG. 3 indicate updates or outputs. Dashed lines shown in FIG. 3 indicate references or acquisitions.

The resource monitoring program P40 and the composition information collection program P46 acquire performance information and composition information from the host 10, the switch 20 and the storage system 30, and use the acquired information to update the resource information management table T40, the network topology management table T41, and the resource performance history management table T42. Note in FIG. 3 that the resource monitoring program P40 and the composition information collection program P46 are gathered into one program for the sake of explanatory convenience; however, these programs can be formed as different programs. Also, the switch 20 is not illustrated in FIG. 3 due to space limitation.

An asset management server 50 is a computer for managing at least part of information (e.g., an installation site, an administrator, etc.) on each of the resources (the host 10, the switch 20, the storage system 30) of the computer system.

The rearrangement availability determination program P41 determines whether to permit the page rearrangement, based on the resource information management table T40, the network topology management table T41, and the resource performance history management table T42. Lines connecting the rearrangement availability determination program P41 to the tables T40 to T43 are not illustrated in FIG. 3.

The rearrangement availability determination program P41 determines, in units of virtual volumes, the availability of the page rearrangement. The result of the determination is stored in the page management table T44 and the rearrangement inhibition history management table T45.

The rearrangement instruction program P42 notifies the storage system 30 of the availability of the rearrangement process based on the determination made by the rearrangement availability determination program P41. Although not shown in FIG. 3, the rearrangement instruction program P42 can refer to the page management table T44.

The warning program P43 refers to the resource information management table T40, the page management table T44, and the rearrangement inhibition history management table T45, to determine whether a warning needs to be issued to the user. When determining that a warning needs to be issued to the user, the warning program P43 presents a pop-up screen G30, which a simplified warning screen, to the user.

The analysis result output program P44 refers to the resource monitoring program P40, the network topology management table T41, the resource performance history management table T42, the page management table T44, and the rearrangement inhibition history management table T45, to analyze a cause that inhibits the rearrangement process. The analysis result output program P44 then presents an analysis result to the user by using analysis result display screens G40, G50, G60. Based on the analysis result, the user can determine whether the communication path within the computer system needs to be changed or not.

The configuration program P45 stores a value input by the user using configuration screens G10, G20, into the resource information management table T40 and the warning management table T43.

Each of the management tables is described next. A composition of each table described hereinafter is merely an example and therefore may have a different composition than those shown in the diagram. For example, each table may include items other than those shown in the diagram, or may omit some of a plurality of items shown in the diagram. The table shown in the diagram may be divided into a plurality of tables, or the plurality of tables shown in the diagram may be gathered into one table.

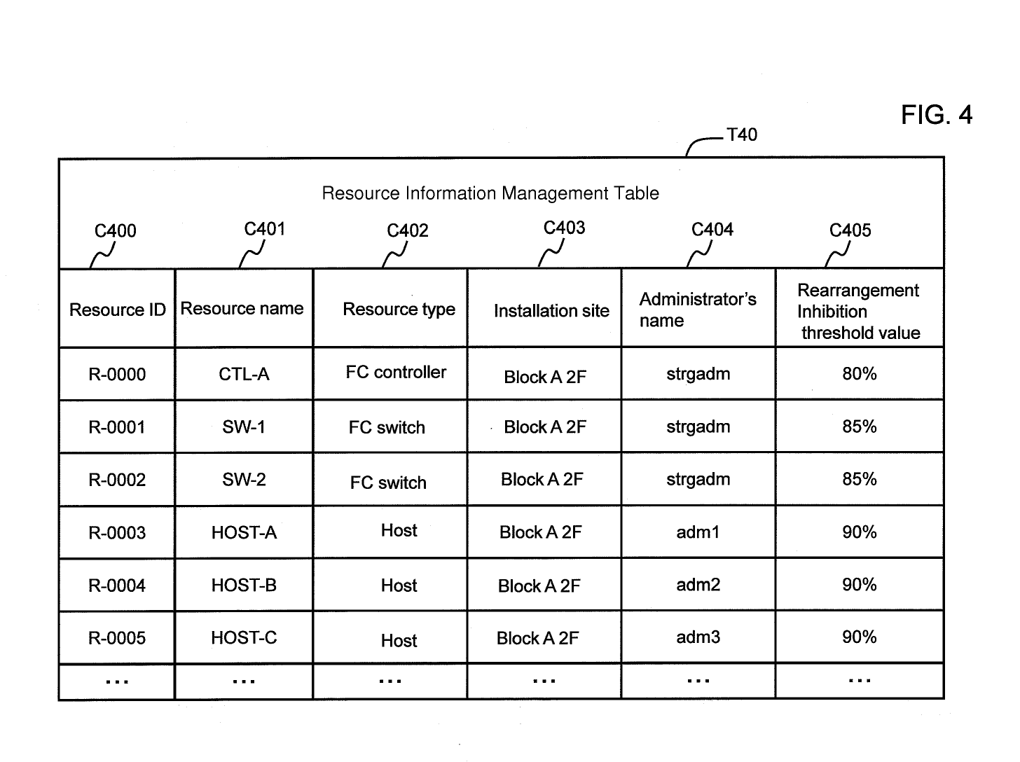

FIG. 4 shows a composition of the resource information management table T40. The resource information management table T40 is a table for managing information on each of the resources of the computer system. At least a part of the resource information management table T40 can be created based on, for example, data stored in the asset management server 50.

The resource information management table T40 manages an association among, for example, a resource identifier C400, a resource name C401, a resource type C402, an installation site C403, an administrator's name C404, and a rearrangement inhibition threshold value C405.

The resource identifier C400 is information for identifying the host 10, the switch 20 and the storage system 30, which are the resources provided in the computer system. The resource name C401 represents the name of each resource. For each of the resources, the user can configure a name that can be understood easily by the user.

The resource type C402 is information indicating the type of each resource. The installation site C403 is information for specifying a site in which each resource is installed. The administrator's name C404 represents the name of a person in charge of managing each resource.

The rearrangement inhibition threshold value C405 represents a threshold value that is configured beforehand for inhibiting the execution of the rearrangement process. The rearrangement inhibition threshold value C405 can be configured for each resource type with respect to a CPU utilization.

For instance, when a resource type is the FC controller, the execution of the rearrangement process on the virtual volume 32 related to the FC controller is inhibited once the utilization of the CPU 310 becomes 80% or higher. For example, when the resource type is the switch, the execution of the rearrangement process on the virtual volume 32 related to the FC switch is inhibited once the utilization of the CPU 21 becomes 85% or higher. For example, when the resource type is the host, the execution of the rearrangement process on the virtual volume 32 related to the host is inhibited once the utilization of the CPU 11 becomes 90% or higher.

The threshold values described above are merely examples, and the rearrangement inhibition threshold value is not limited thereto. Furthermore, instead of configuring the rearrangement inhibition threshold value C405 for each resource type, the rearrangement inhibition threshold value C405 may be configured for each resource. A threshold value that is defined beforehand for each resource type may be configured as an initial value of the rearrangement inhibition threshold value C405, to allow the user to manually configure each initial value.

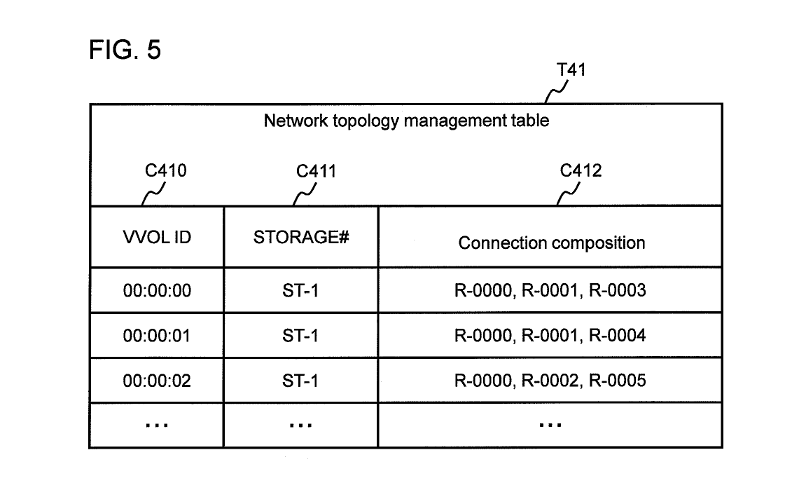

FIG. 5 shows a composition of the table T41 managing a network topology. The network topology management table T41 manages an association among, for example, a virtual volume identifier C410, a storage system identifier C411, and a connection composition information C412.

The virtual volume identifier C410 is information for identifier each virtual volume 32. The storage system identifier (storage system number) C411 is information for identifying the storage system 30. The connection composition information C412 is information indicating a connection sequence of the resources that exists on the communication path used by the host 10 to access the virtual volumes 32 within the storage system 30.

For example, “R-0000” indicates the FC controller 31. Numerals “R-0001” and “R-0002” indicate the switch 20. Numerals “R-0003,” “R-0004,” and “R-0005” indicate the host 10. When “R-0000, R-0001, R-0003” are written in the connection composition information C412, it means that the host (R-0003) is connected to the virtual volume 32 specified by the virtual volume identifier C410, via the FC controller (R-0000) and the switch (R-0001).

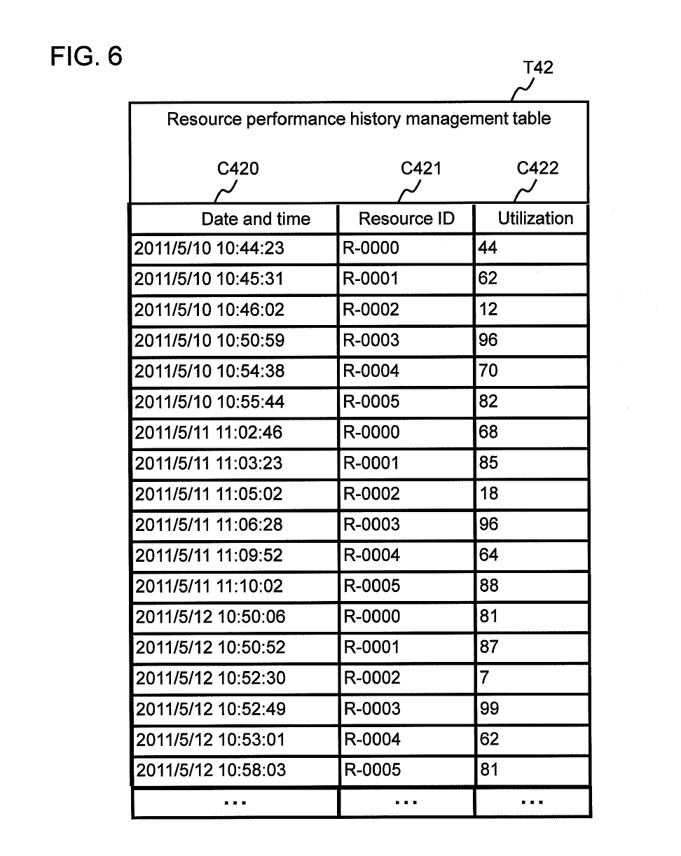

FIG. 6 shows a composition of the table T42 managing a performance history of each resource. The resource performance history management table T42 manages an association among, for example, a date and time C420, a resource identifier C421, and a utilization C422. The date and time C420 indicates a date and time at which performance information of each resource is acquired. The utilization C422 indicates the CPU utilization as the performance information of each resource.

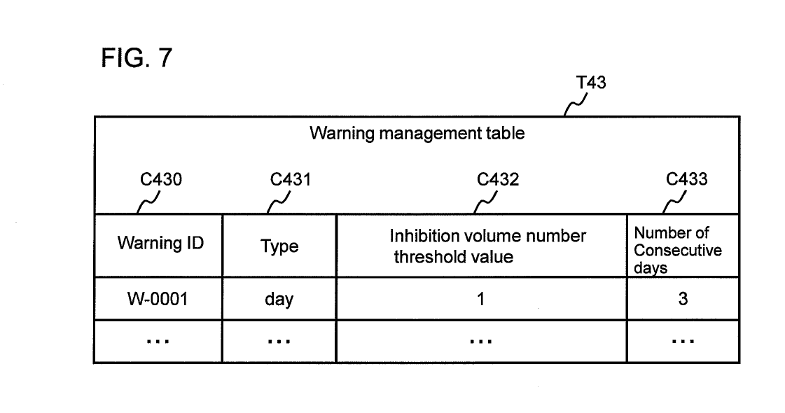

FIG. 7 shows a composition of the table T43 managing a warning threshold value. The warning management table T43 manages an association among, for example, a warning identifier C430, a type C431, an inhibition volume number threshold value C432, and the number of consecutive days C433.

The warning identifier C430 is information for identifying a warning issued to the user. The type C431 indicates the type of a warning. Examples of the type of a warning include “day.” The term “day” means a warning that is issued when the execution of the rearrangement process on a predetermined number (C432) or more of virtual volumes is inhibited for a predetermined number of days (C433) or more.

The inhibition volume number threshold value C432 is a part of a warning condition for issuing a warning and indicates the number of virtual volumes 32 on which the execution of the rearrangement process is inhibited. The number of consecutive days C433 forms the warning condition along with the inhibition volume number threshold value C432 and indicates the number of consecutive days for which the number of virtual volumes (the execution of the rearrangement process on these virtual volumes is inhibited) becomes the threshold value C432 or above.

Note that a predetermined number of consecutive unit times or a cumulative total, such as three hours, six hours, twelve hours, one week, one month or the like, may be configured as the number of consecutive days. In the example shown in FIG. 7, a warning is output to the user when one or more virtual volumes on which the execution of the rearrangement process is inhibited is present for three consecutive days. A warning is issued to the user, not only when the execution of the rearrangement process on the same virtual volumes is inhibited for three consecutive days, but also when the execution of the rearrangement process on different virtual volumes is inhibited for three consecutive days.

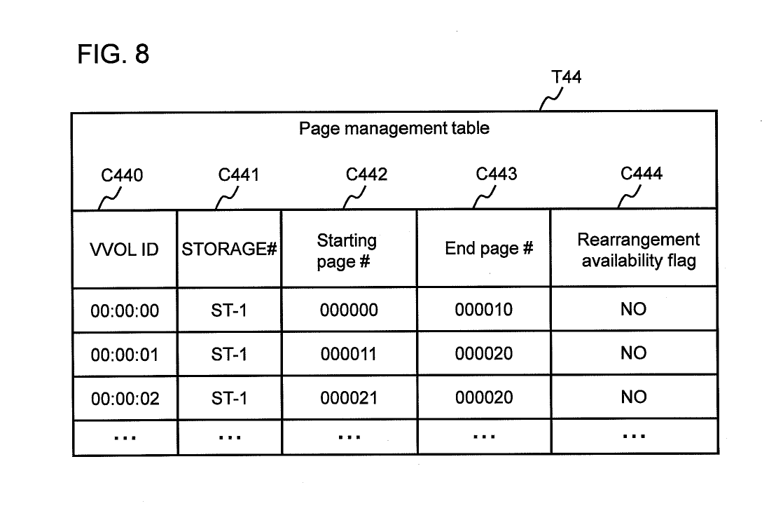

FIG. 8 shows a composition of the table T44 managing each logical page 320 of the virtual volume 32. The page management table T44 manages an association among, for example, a virtual volume identifier C440, a storage system identifier C441, a starting page number C442, an end page number C443, and a rearrangement availability flag C444.

The starting page number C442 is information for specifying the top logical page 320 out of the logical pages 320 forming the virtual volume 32 specified by the virtual volume identifier C440. The end page number C443 is information for specifying the last logical page 320 out of the logical pages 320 forming the same virtual volume 32.

The rearrangement availability flag C444 is information used for defining the availability of the page rearrangement. For example, when the execution of the rearrangement is permitted, “YES” is configured. When the execution of the rearrangement is inhibited, “NO” is configured.

In the present embodiment, when “NO” is configured in the rearrangement availability flag C444, the execution of the rearrangement only on higher tiers is inhibited, and the execution of the rearrangement on lower tiers is permitted. Under a circumstance where each resource related to the virtual volume 32 has a performance problem, an improvement of the response performance of the storage system 30 cannot be expected from simply moving the data of the logical pages 320 to the tiers higher than the tier 33 to which the data currently belong. However, a space can be created in a current arrangement destination tier by moving the data to the tiers lower than the tier to which the data currently belong. The overall response performance of the storage system 30 can be improved by storing the data of the logical pages 320 of the other virtual volumes 32 into this space area.

Note in the present embodiment that a single rearrangement availability flag C444 is commonly applied to each logical page 320 of the virtual volumes 320. Instead, the rearrangement availability flag may be configured for each logical page.

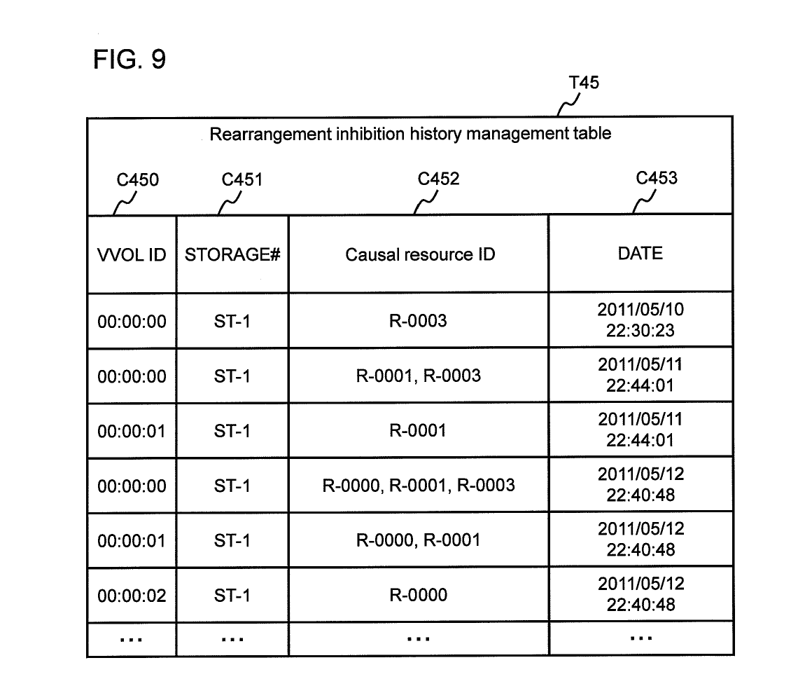

FIG. 9 shows a composition of the table T45 managing histories of inhibition of the rearrangement process. The rearrangement inhibition history management table T45 manages an association among, for example, a virtual volume identifier C450, a storage system identifier C451, a causal resource identifier C452, and a date C453.

The causal resource identifier C452 is information for specifying a resource that is the cause of inhibition of the rearrangement process when the execution of the rearrangement process on the virtual volume 32 specified by the virtual volume identifier C450 and the storage system identifier C451 is inhibited. The date C453 indicates a date and time at which the inhibition of the rearrangement process is determined.

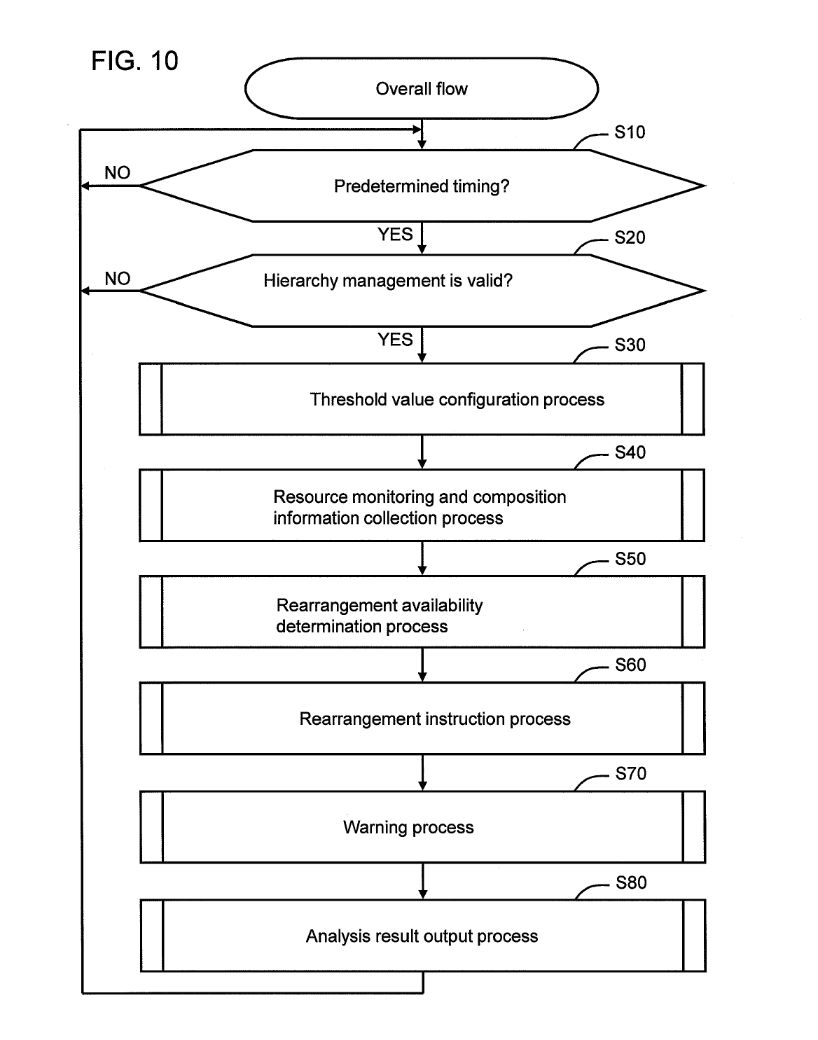

FIG. 10 is a flowchart showing a flow of the entire operation performed by the management computer 40. The management computer 40 determines whether a predetermined timing that is configured in advance has come or not (S10). When the predetermined timing has come (S10: YES), the management computer 40 determines whether hierarchy control is performed on the pool 34 or not (S11). In other words, each of the following processes is executed when each of the virtual volumes 32 is managed by automatic hierarchization, which is a premise of the present embodiment.

The predetermined ting determined in step S10 can be selected from among (T1) prior to the execution of the rearrangement process by the storage system, (T2) when a time designated by the user has come, and (T3) when loads on a plurality of predetermined resources reach a monitoring start threshold value for starting a monitoring process.

In a case of (T1), the management computer 40 executes the process shown in FIG. 10, before the storage system 30 executes the periodical rearrangement process.

In a case of (T2), the management computer 40 executes the process shown in FIG. 10, when a date and time designated beforehand by the user.

In a case of (T3), the management computer 40 executes the process shown in FIG. 10 when the load (e.g., the CPU utilization) of any one of the resources related to the virtual volume 32 reaches the monitoring start threshold value that is configured in advance. The monitoring start threshold value is configured as a value smaller than the values described in the rearrangement inhibition threshold value C405 of the resource information management table T40. For instance, when the resource is the FC controller, the monitoring start threshold value may be configured at 75%. When the resource is the switch, the monitoring start threshold value may be configured at 80%. When the resource is the host, the monitoring start threshold value may be configured at 85%.

The timings described above can be combined appropriately. When combining the timing T1 with the timing T2, the management computer 40 executes the process shown in FIG. 10, for example, after the date and time designated by the user has come and before the storage system 30 executes the rearrangement process.

In addition, the management computer 40 may execute the process shown in FIG. 10 when any one of the timings T1, T2 and T3 has come.

When the predetermined timing has come (S10: YES) and the hierarchy control is performed on the pool 34 (S11: YES), the management computer 40 executes a threshold value configuration process (S30) and a resource monitoring and composition information collection process (S40).

The management computer 40 further executes a rearrangement availability determination process (S50) and a rearrangement instruction process (S60). The management computer 40 further executes a warning process (70) and an analysis result output process (S80). Each of these processes is described hereinafter in detail.

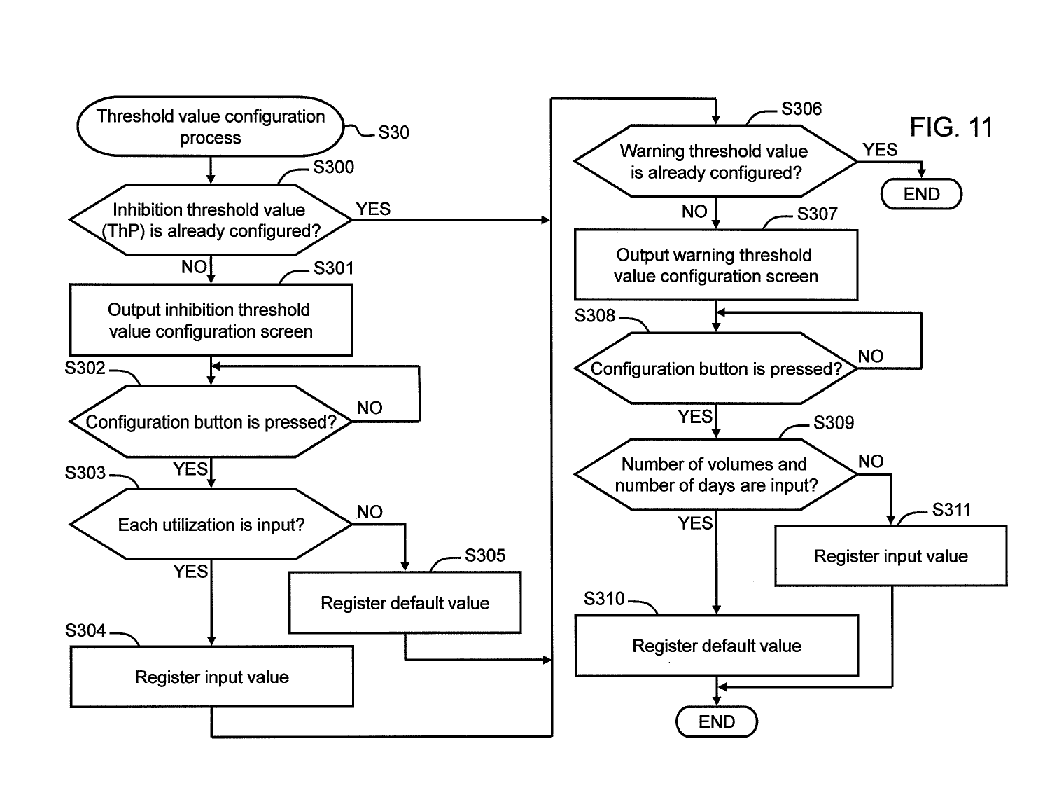

FIG. 11 is a flowchart showing a process for configuring threshold values. This process illustrates the details of step S30 shown in FIG. 10.

First of all, the management computer 40 determines whether or not a threshold value for inhibiting the rearrangement is configured in the section C405 of the resource information management table T40 (S300). The diagram often shows the rearrangement inhibition threshold value as “ThP.” The rearrangement inhibition threshold value in the diagram is often abbreviated as “inhibition threshold value.”

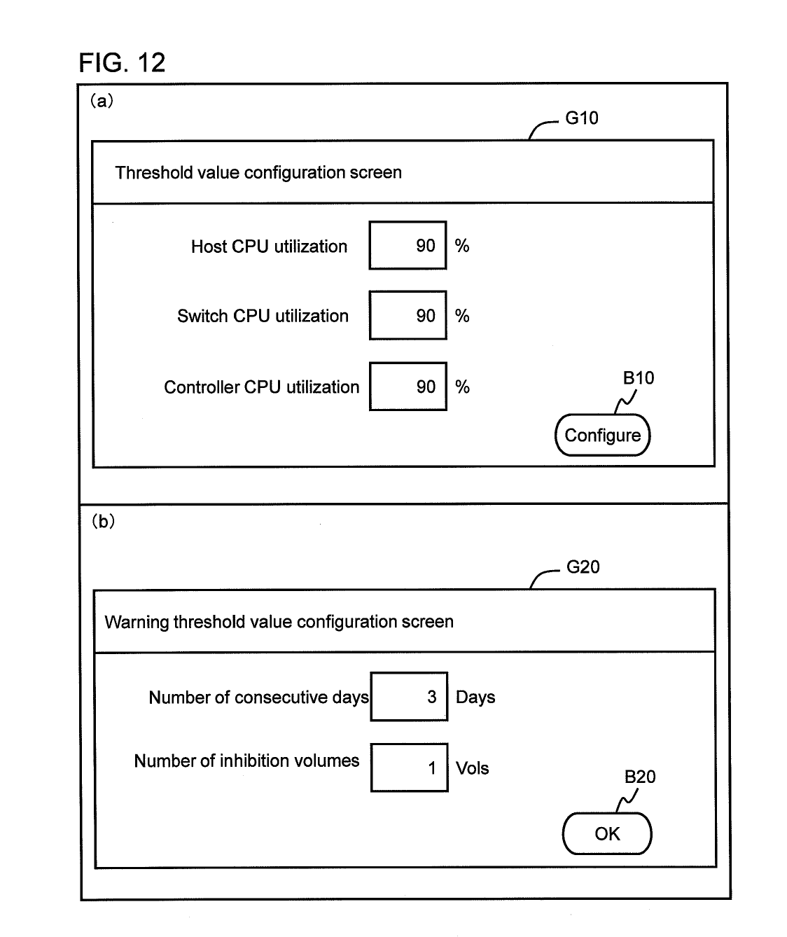

When the rearrangement inhibition threshold value is not configured (S300: NO), the management computer 40 creates and displays the threshold value configuration screen G10 shown in FIG. 12(a) (S301). The user can configure each threshold value for inhibiting the execution of the rearrangement process, for each resource type, by means of the threshold value configuration screen G10 shown in FIG. 12(a).

The management computer 40 determines whether a configuration button B10 of the threshold value configuration screen G10 is pressed or not (S302). When the configuration button B10 is pressed (S302: YES), the management computer 40 determines whether or not the CPU utilization (threshold value) for each resource type is input on the threshold value configuration screen G10 (S303).

When numerical values other than 0 are input in the entry fields on the threshold value configuration screen G10 (S303: YES), the management computer 40 registers these input values in the section C405 of the resource information management table T40 (S304).

When, on the other hand, no numerical values are input in the threshold value configuration screen G10 (S303: NO), the management computer 40 registers a default value of 100% in the section C405 of the resource information management table T40 (S305).

Next, the management computer 40 determines whether the warning threshold values are configured in the warning management table T43 (S306). When the rearrangement inhibition threshold values are configured in the resource information management table T40 (S300: YES), steps S301 to S305 are skipped, and the process proceeds to step S306.

When the warning threshold values are configured (S306: YES), the management computer 40 ends this process. When no warning threshold values are configured (S306: NO), the management computer 40 displays the warning threshold value configuration screen G20 shown in FIG. 12(b) (S307). The user inputs, as the warning conditions, the number of consecutive days and the number of virtual volumes on which the execution of the rearrangement process is inhibited, by means of the warning threshold value configuration screen G20.

The management computer 40 determines whether a configuration button B20 of the warning threshold value configuration screen G20 is pressed or not (S308). When the configuration button B20 is pressed by the user (S308: YES), the management computer 40 determines whether the number of inhibited volumes and the number of consecutive days are input as the warning conditions (S309).

When the number of inhibited volumes and the number of consecutive days are input (S309: YES), the management computer 40 registers the input values in the warning management table T43 (S310).

When at least either the number of inhibited volumes or the number of consecutive days is not input (S309: NO), the management computer 40 registers, in the warning management table T43, a default value that is prepared in advance (S310). The default value is defined in advance as, for example, “the number of inhibited volumes=1, the number of consecutive days=3 days.”

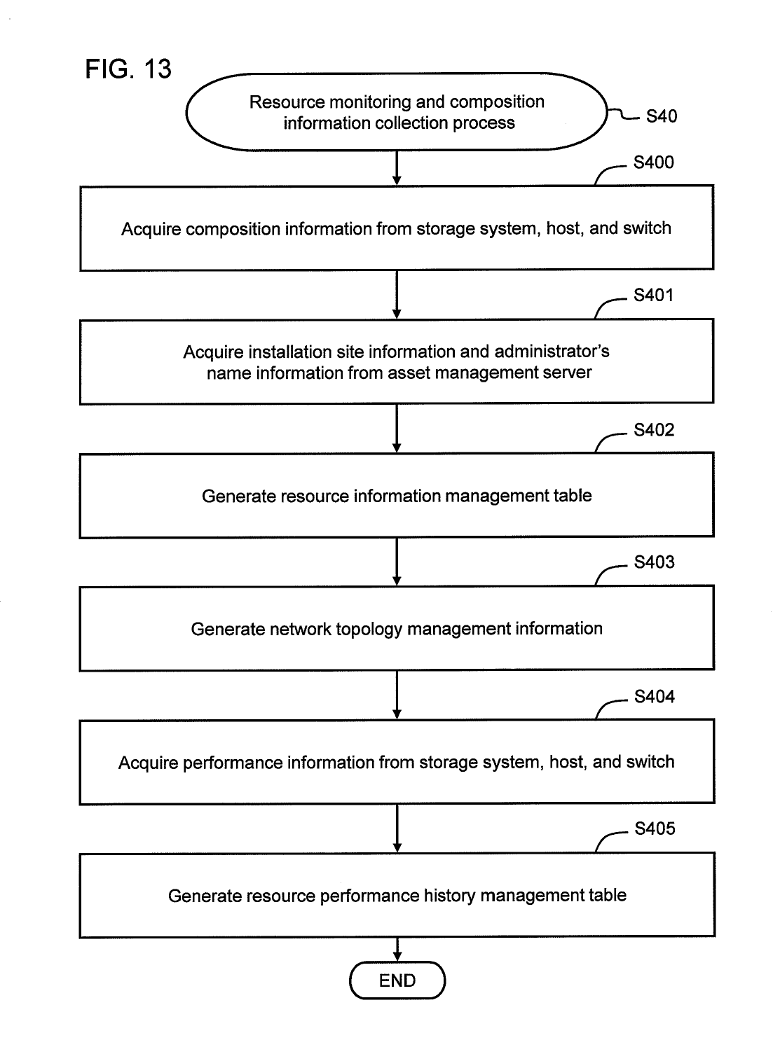

FIG. 13 is a flowchart of a process for monitoring the resources and collecting the composition information. FIG. 13 shows the details of step S40 shown in FIG. 10.

The management computer 40 collects the composition information from the host 10, the switch 20 and the storage via the management communication network CN2 (S400). The management computer 40 further acquires the installation site and the administrator's name for each resource from the asset management server 50 (S401). The management computer 40 creates the resource information management table T40 based on the information acquired in steps S400 and S401 (S402). Note that the warning threshold values are registered in the resource information management table T40 in the process shown in FIG. 11, as described above.

The management computer 40 creates the network topology management table T41 based on the composition information acquired in step S400 (S403).

The management computer 40 further acquires the performance information from the host 10, the switch 20 and the storage system 30 (S404), and generates the resource performance history management table T42 (S405).

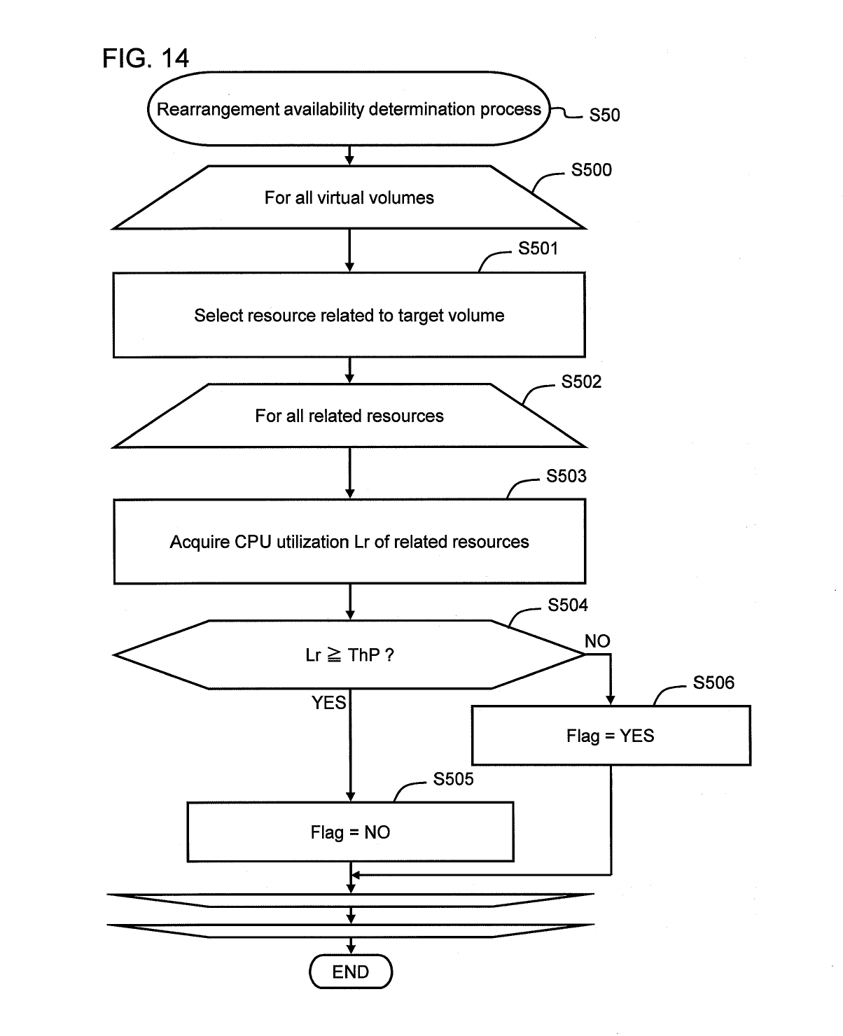

FIG. 14 is a flowchart of a process for determining the availability of the rearrangement process. The process shown in FIG. 14 illustrates the details of step S50 shown in FIG. 10.

The management computer 40 executes the following steps S501 to S506 for all of the virtual volumes 32 described in the page management table T44 (S500).

The management computer 40 selects one of the virtual volumes described in the page management table T44 as a target volume, and acquires information on the resources related to the target volume, from the network topology management table T41 (S501). The resources related to the target volume mean the resources existing on the access path to the virtual volume 32 to be processed, and are also referred to as “related resources.”

The management computer 40 executes the following steps S503 to S506 for all of the extracted related resources (S502). The management computer 40 acquires the CPU utilizations Lr of the related resources (S503).

The management computer 40 determines whether the CPU utilizations Lr of the related resources are equal to or greater than the rearrangement inhibition threshold value ThP (S504). When the CPU utilizations Lr are equal to or greater than the rearrangement inhibition threshold value ThP (S504: YES), the management computer 40 configures “NO” as the rearrangement availability flag for the target volume 32 (S505). However, when the CPU utilizations Lr are less than the rearrangement inhibition threshold value ThP (S504: NO), the management computer 40 configures “YES” as the rearrangement availability flag for the target volume 32 (S506).

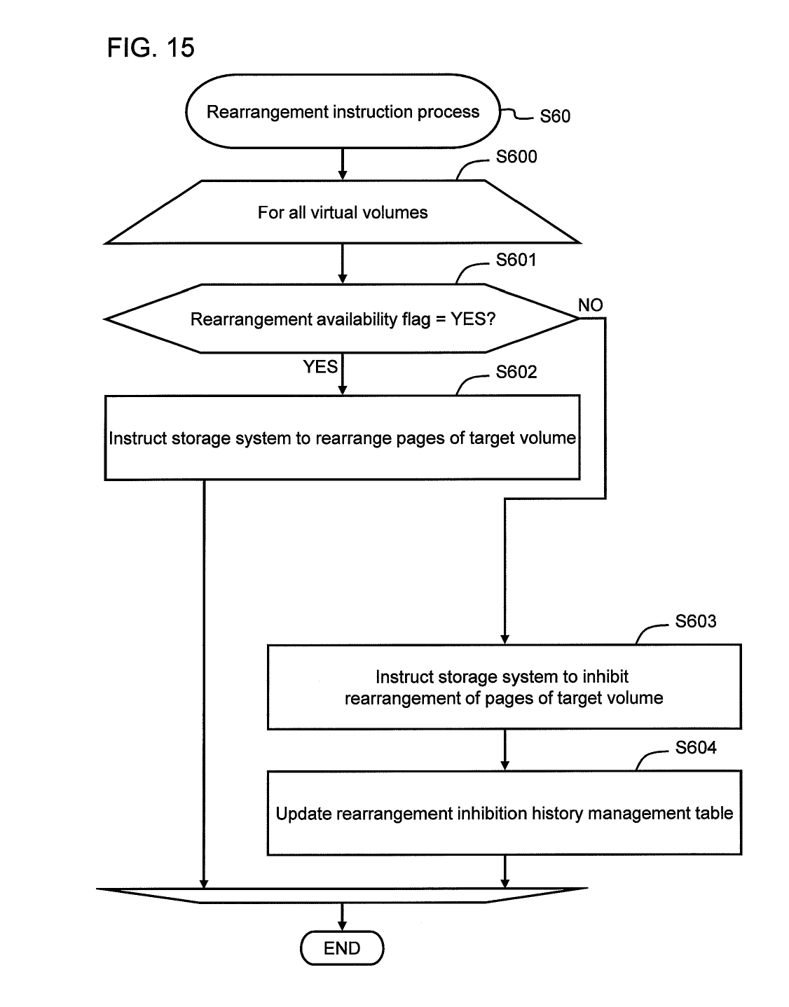

FIG. 15 a flowchart of a process for instructing the storage system 30 on the execution of the rearrangement process. This process illustrates the details of step S60 shown in FIG. 10.

The management computer 40 executes the following steps S601 to S604 for all of the virtual volumes 32 described in the page management table T44 (S600). The management computer 40 selects one of the virtual volumes 32 from the page management table T44 as a volume to be processed.

The management computer 40 determines whether “YES” is configured as the rearrangement availability flag for the target volume (S601). When “YES” is configured as the rearrangement availability flag (S602), the management computer 40 instructs the storage system 30 to execute the rearrangement process on the target volume (S603).

When “NO” is configured as the rearrangement availability flag (S601: NO), the management computer 40 instructs the storage system 30 to inhibit the execution of the rearrangement process on the target volume (S603).

The management computer 40 prohibits the data of the target volume from being rearranged to the tiers (the tiers of higher performances) that are higher than the tier to which the data of the target volume currently belong, but permits the data of the target volume to be rearranged to the tiers (the tiers of lower performances) that are lower than the tier to which the data of the target volume current belong. The management computer 40 updates the rearrangement inhibition history management table T45 based on the instruction on the inhibition of the rearrangement process, the instruction being given in step S603.

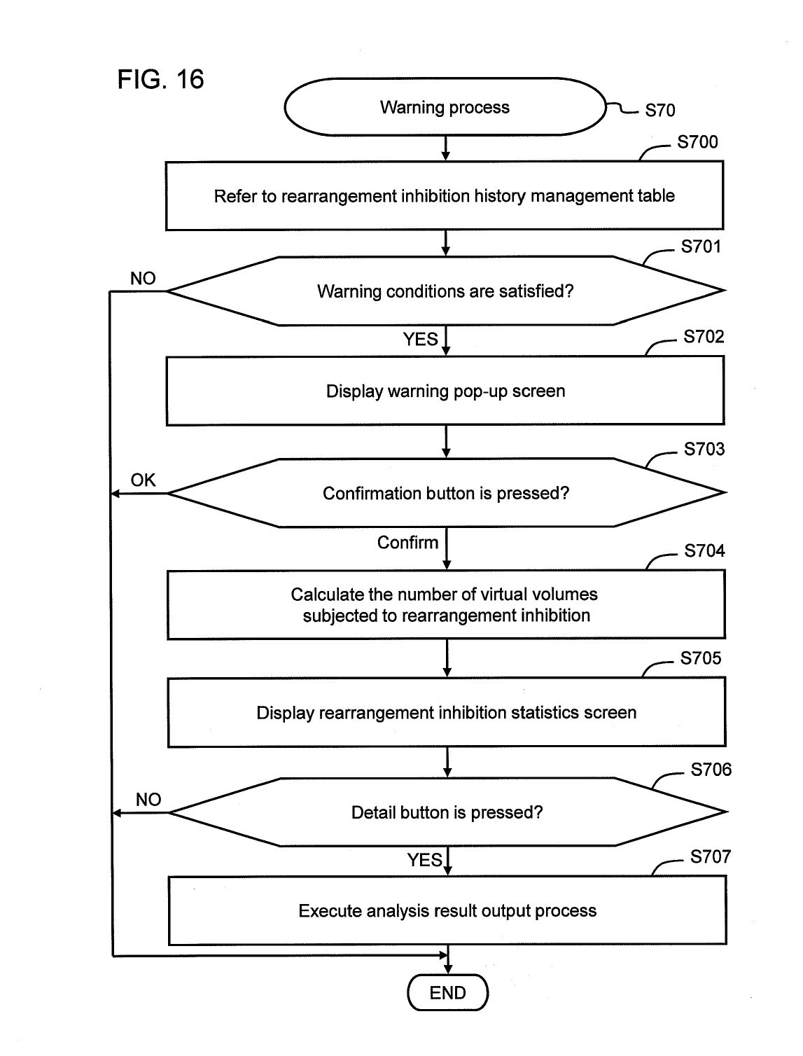

FIG. 16 is a flowchart showing a process of issuing a warning to the user. The process shown in FIG. 16 illustrates the details of step S70 shown in FIG. 10.

The management computer 40 refers to the rearrangement inhibition history management table T45 (S700) to determine whether the warning conditions registered in the warning management table T43 are satisfied or not (S701). The management computer 40 determines whether the execution of the rearrangement process on a predetermined number or more of virtual volumes 32 is inhibited for a predetermined period of time or longer. In the example shown in FIG. 7, the warning conditions are satisfied when the execution of the rearrangement process on the same virtual volumes is inhibited for three consecutive days, or when the execution of the rearrangement process on different virtual volumes is inhibited for three consecutive days.

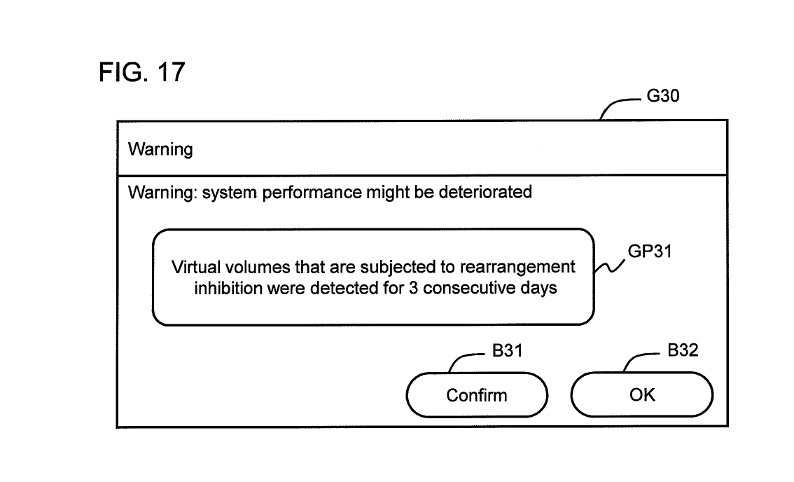

When the warning conditions are satisfied (S701: YES), the management computer 40 displays the warning pop-up screen G30 (S702). As shown in FIG. 17, the warning pop-up screen G30 has, for example, a region GP31 for displaying a warning message, a confirmation button B31, and an OK button B32. The management computer 40 warns the user about the possibility of a system performance degradation by presenting the pop-up screen G30 to the user.

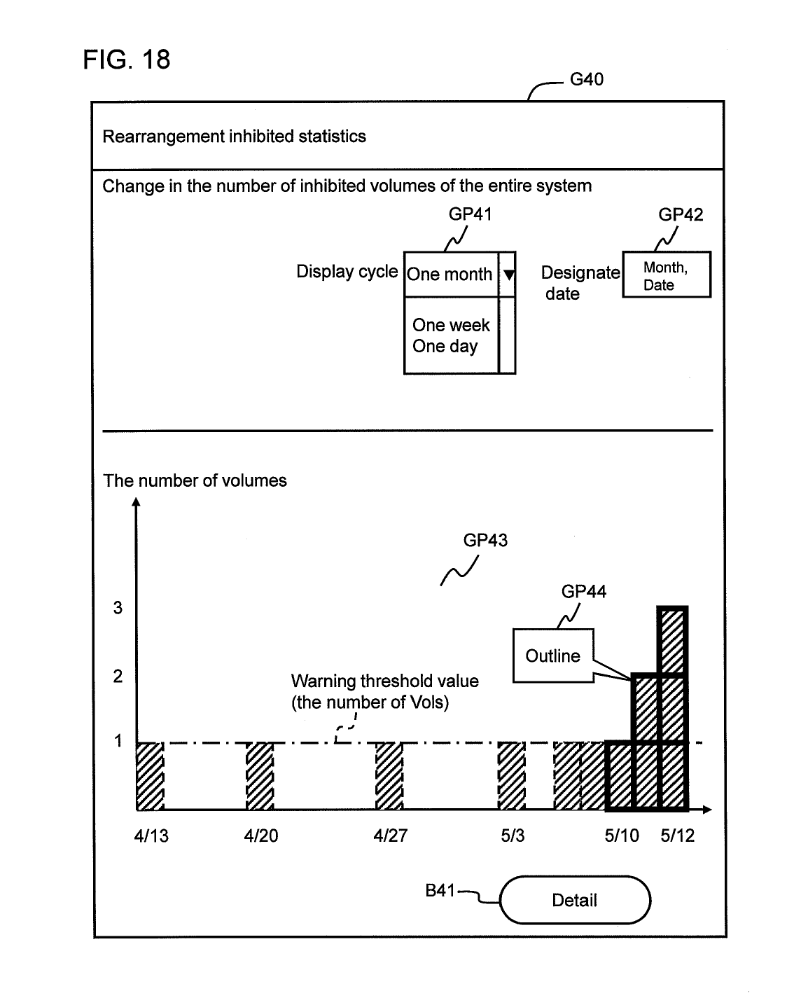

Returning to FIG. 16, the management computer 40 determines whether the confirmation button B31 is pressed by the user or not (S703). When the confirmation button B31 is pressed (S703: confirmed), the management computer 40 refers to the rearrangement inhibition history management table T45, and calculates the number of virtual volumes 32 on which the execution of the rearrangement process is inhibited within a predetermined display target period (S704). The management computer 40 then creates and displays the rearrangement inhibition statistics screen G40 shown in FIG. 18 (S705).

The screen G40 shown in FIG. 18 shows statistics regarding the inhibition of the execution of the rearrangement process, and has period designation parts GP41, GP42 for designating a statistics display target period, a graph display part GP43 for displaying the statistics in the form of a graph, an outline display part GP44, and a detail button B41. A display cycle of, for example, one month, one week, one day, or the like can be designated as the display target period (GP41), and a specific date can be designated as well (GP42).

The vertical axis of the graph display part GP43 shows the number of virtual volumes on which the execution of the rearrangement process is inhibited, and the horizontal axis shows the display target period designated through the designation part GP41 or GP42. The resolution of the scale of the horizontal axis varies depending on the duration of the display target period. For instance, when changes occurring in a long duration, such as one month, the changes are displayed in units of days. However, when displaying changes occurring in one certain day, changes are displayed every predetermined time, such as every hour or every three hours. When the user selects a desired bar on the bar graph, the outline of the selected bar is displayed. The outline can include, for example, the identifiers of the virtual volumes on which the execution of the rearrangement process is inhibited.

In FIG. 18, warning targets, which are the virtual volumes on which the execution of the rearrangement process is inhibited, are surrounded by thick lines. In addition, the graph display part GP43 can also display the inhibited volumes that do not satisfy the warning conditions (the virtual volumes on which the execution of the rearrangement process is inhibited). These virtual volumes that do not satisfy the warning conditions and on which the execution of the rearrangement process is in habited are surrounded by chain lines.

Returning to FIG. 16, the management computer 40 determines whether the detail button B40 is pressed by the user or not (S706). When the detail button B40 is pressed (S706: YES), the management computer 40 executes the analysis result output process (S707). The analysis target period may be the entire warning period or may be selected from the screen by the user.

When there are no virtual volumes satisfying the warning conditions (S701: NO), or when the confirmation button B31 on the screen G30 is not pressed (S703: OK), or when the detail button B41 on the screen G40 is not pressed (S706: NO), this process is ended.

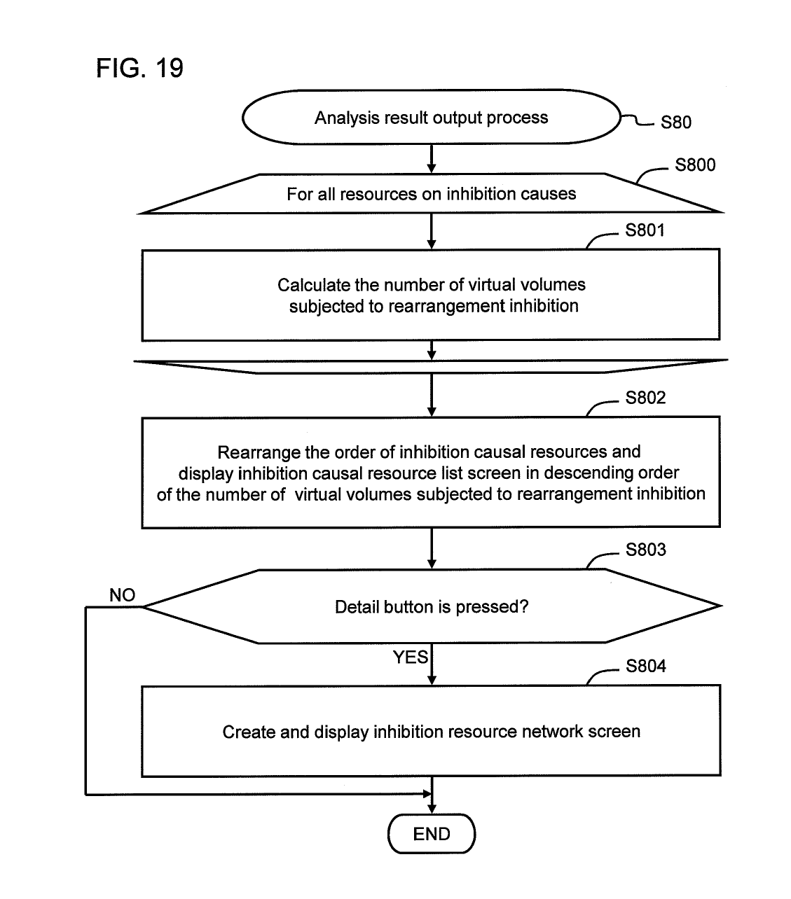

FIG. 19 is a flowchart of a process for outputting analysis results. This process illustrates the details of step S80 shown in FIG. 10.

The management computer 40 calculates the number of virtual volumes on which the execution of the rearrangement process is inhibited (S801), with respect to all of the causal resources that cause the inhibition of the rearrangement process during an analysis target period (S800).

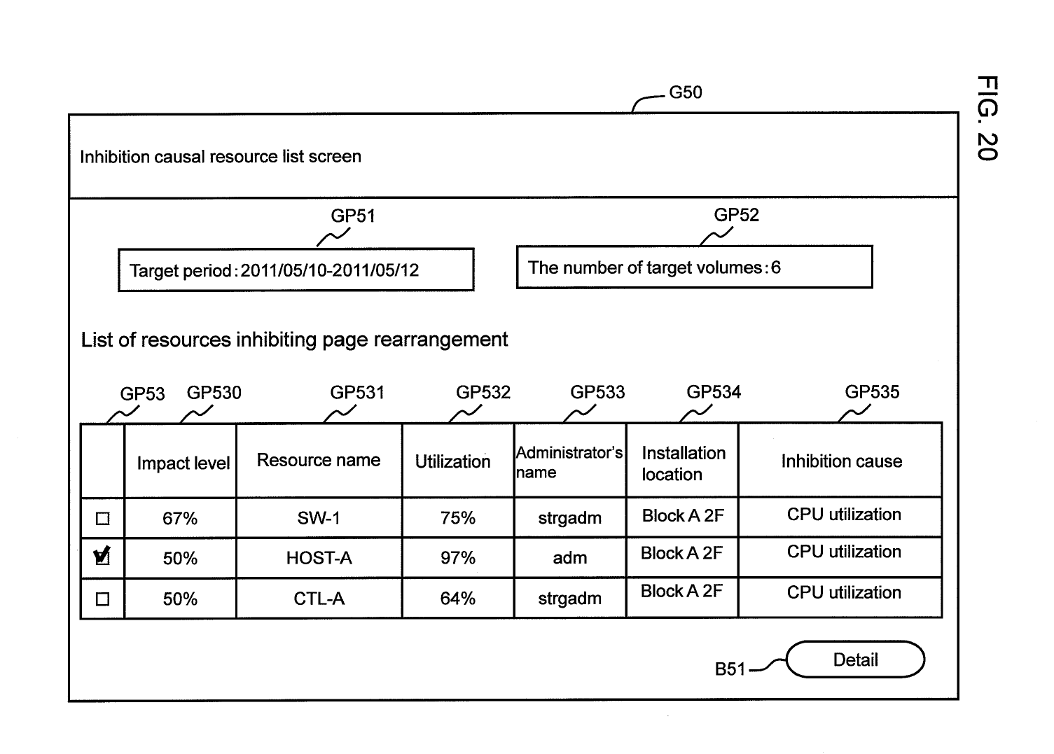

The management computer 40 creates and displays the inhibition causal resource list screen G50 shown in FIG. 20 by rearranging the order of the causal resources in descending order of the number of virtual volumes on which the execution of the rearrangement process is inhibited (S802).

The screen G50 shown in FIG. 20 shows a list of the resources that cause the inhibition of the rearrangement process during the analysis target period. This screen G50 has, for example, a display part GP51 for displaying the analysis target period, a display part GP52 for displaying a total number of virtual volumes on which the execution of the rearrangement process is inhibited within the analysis target period, a list display part GP53, and a detail button B51.

The list display part GP53 display an association among, for example, an impact level GP530, a resource name GP531, a CPU utilization GP532, an administrator's name GP533, an installation site GP534, and an inhibition cause GP535.

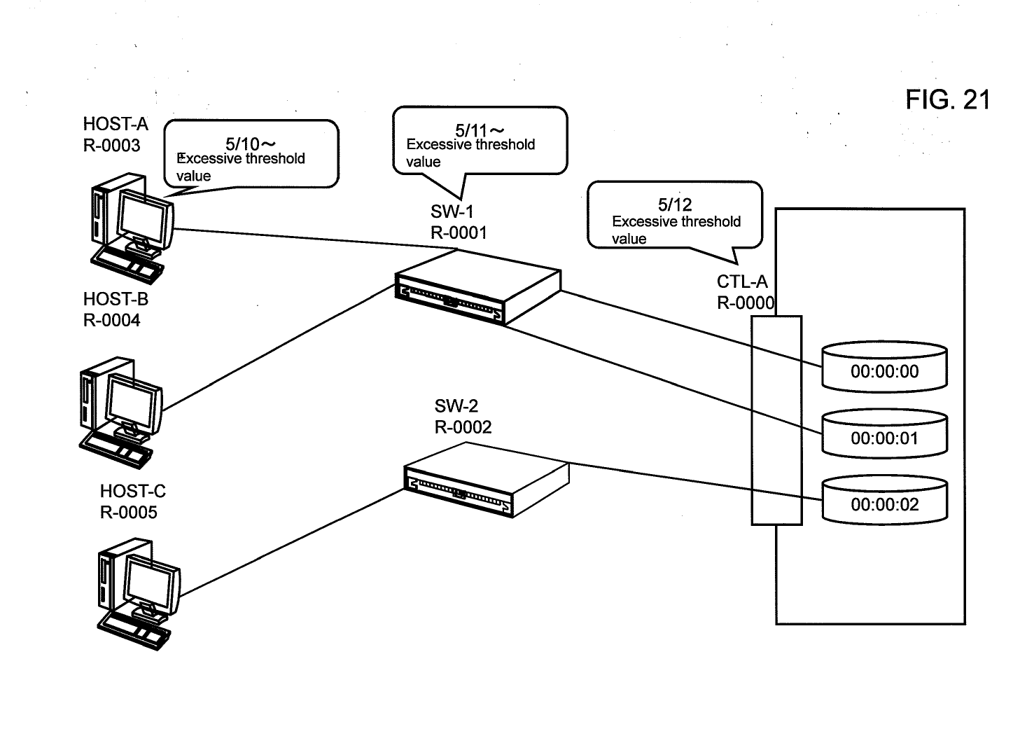

The impact level GP530 indicates the impact of each resource on the cumulative total of the virtual volumes on which the execution of the rearrangement process is inhibited within the analysis target period. For example, a situation in which the execution of the rearrangement process on a total of six virtual volumes is inhibited within the analysis target period is explained with reference to FIG. 21.

FIG. 21 shows a relationship between the resources that cause the inhibition of the execution of the rearrangement process and the virtual volumes on which the execution of the rearrangement process is inhibited due to the resources.

In FIG. 21, a virtual volume (00:00:00) is connected to the host (R-0003) via the FC controller (R-0000) and the switch (R-0001). Similarly, another virtual volume (00:00:01) is connected to another host (R-0004) via the FC controller (R-0000) and the switch (R-0001). Yet another virtual volume (00:00:02) is connected to the host (R-0005) via the FC controller (R-0000) and another switch (R-0002).

As shown in FIG. 21, suppose that the CPU utilization of the host (R-0003) exceeds the inhibition threshold value on 5/10 (May 10), that the CPU utilization of the switch (R-0001) exceeds the inhibition threshold value on 5/11 (May 11), and that the CPU utilization of the FC controller (R-0000) of the storage system exceeds the inhibition threshold value on 5/12 (May 12). Also, suppose that the current date is 5/12 (May 12).

Because the virtual volume (00:00:00) is used by the host (R-0003), the execution of the rearrangement process is inhibited when the CPU utilization of the host (R-0003) exceeds the inhibition threshold value.

Therefore, the execution of the rearrangement process on the virtual volume (00:00:00) is inhibited for three days of 5/10, which is the first day, 5/11, which is the second day, and 5/12, which is the third day. The virtual volume (00:00:00) accounts for three out of the cumulative total of six virtual volumes on which the execution of the rearrangement process is inhibited. Thus, the level of the impact of the host (R-0003) on the inhibition of the rearrangement process within the analysis target period is 50% (=3/6).

The switch (R-0001) is connected to the virtual volume (00:00:00) and the virtual volume (00:00:01). When the CPU utilization of the switch (R-0001) exceeds the inhibition threshold value, the execution of the rearrangement process on the virtual volumes (00:00:00), (00:00:01) is inhibited. The execution of the rearrangement process on two virtual volumes is inhibited on 5/11, and the execution of the rearrangement process on two virtual volumes is inhibited on the next day, 5/12, as well. The switch (R-0001) is a cause of the inhibition of the rearrangement process for a total of four virtual volumes. Therefore, the level of the impact of the switch (R-0001) on the inhibition of the rearrangement process within the analysis target period is approximately 67% (=4/6).

The FC controller (R-0000) is connected to the virtual volume (00:00:00), the virtual volume (00:00:01), and the virtual volume (00:00:02). When the CPU utilization of the FC controller (R-0000) exceeds the inhibition threshold value on 5/12, the execution of the rearrangement process on a total of three virtual volumes is inhibited accordingly. Therefore, the level of the impact of the FC controller (R-0000) on the inhibition of the rearrangement process within the analysis target period is 50% (=3/6).

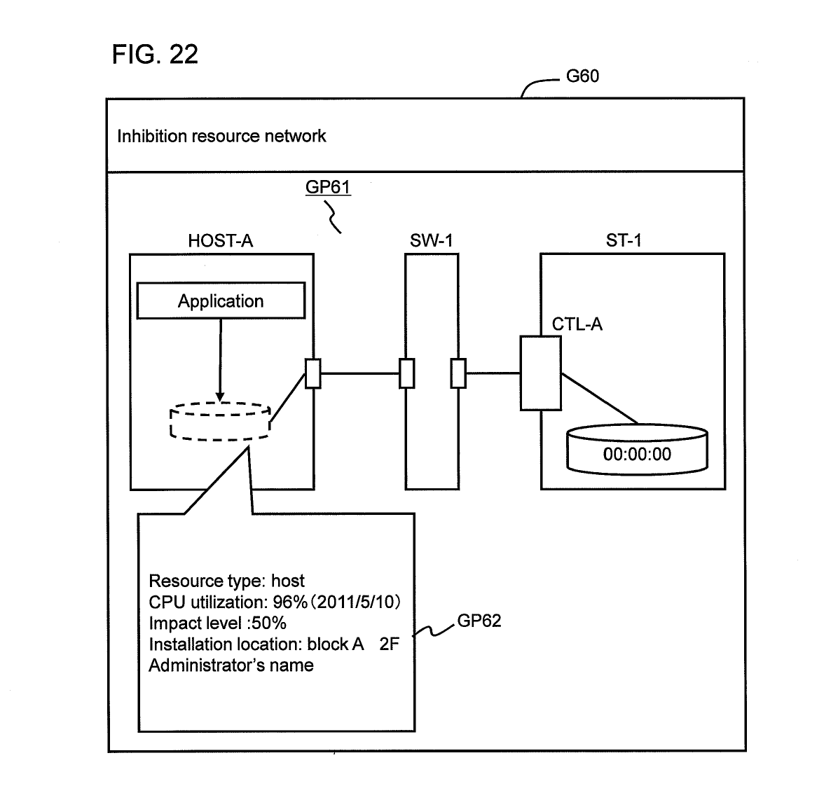

Returning to FIG. 19, the management computer 40 determines whether the detail button B51 on the screen G50 is pressed by the user or not (S803). When the detail button B51 is pressed (S803: YES), the management computer 40 creates and displays the inhibition resource network screen G60 shown in FIG. 22 (S804).

The inhibition resource network screen G60 shown in FIG. 22 shows a relationship of the virtual volumes 32 on which the execution of the rearrangement process is inhibited, to the resources causing the inhibition of the rearrangement process, as a network connection composition diagram GP61.

An outline display part GP62 for displaying the outlines of the inhibition causal resources is associated with the inhibition causal resources. Using this screen G60, the user can easily understand which virtual volume 32 is subjected to the rearrangement inhibition, and for what reason the execution of the rearrangement process is inhibited by certain resources.

The embodiment described above achieves the following effects. This embodiment monitors whether bottleneck resources (causal resources) of high CPU utilizations exist among resources on the access paths to the virtual volumes 32. In the present embodiment, when the causal resources are found, the execution of the rearrangement process on the virtual volumes 32 related to the causal resources is inhibited. In this manner, a meaningless rearrangement process that is not expected to improve the response performance of the storage system can be prevented from happening. In addition, the storage regions of the rearrangement destination tiers can be allocated to the data of the other virtual volumes, improving the response performance of the entire storage system 30.

The present embodiment prohibits data from being rearranged to the tiers having higher performances than the current tier, and permits data from being rearranged to the tiers having lower performances than the current tier. Therefore, in a case of a low access frequency to the virtual volume 32 with the causal resource on the access path, the virtual volume 32 is then rearranged to the tier having a lower performance than the current tier. This leads to the formation of a space area in the tier where the virtual volume exists, so that another virtual volume can be arranged in this space area. Therefore, the response performance of the entire storage system 30 can be improved by effectively utilizing the storage resource of the storage system 30.

Moreover, when the inhibition of the rearrangement process is determined, and when the determination on the inhibition of the rearrangement process satisfies the warning conditions, the present embodiment presents the warning screen G30 to the user instead of immediately notifying the user of such determination.

Thus, in the present embodiment, the user friendliness is improved because the inhibition of the rearrangement process caused due to a transitory phenomenon does not have to be notified to the user. For instance, in a relatively large computer system such as a data center, a number of warnings are issued to a user daily. In such a circumstance, however, it is troublesome to always notify the user of the inhibition of the rearrangement process caused by a minor problem. In the present embodiment, on the other hand, the user is notified of the inhibition of the rearrangement process only when the warning conditions are satisfied. Therefore, the user friendliness can be improved.

In addition, when warning the user about the inhibition of the rearrangement process, the present embodiment notifies the user of also the past inhibition of the rearrangement process for which the warning conditions are no satisfied. This helps the user determine whether the execution of the rearrangement process is inhibited due to a transitory phenomenon or due to a phenomenon that occurs relatively regularly. When the execution of the rearrangement process is inhibited over a relatively long period of time, the user can assume that the computer system has some kind of problems that need to be fixed.

Furthermore, the present embodiment analyzes the relationship between the virtual volume on which the execution of the rearrangement process is inhibited and the resource causing the inhibition of the rearrangement process, and then displays the relationship as the inhibition resource network screen G60. Thus, the user can assume which part of the computer system has problems that need to be fixed, and can determine whether the compositions of the computer system need to be changed or not.

According to the present embodiment, the status of each of the resources of the computer system can be monitored so that the execution of a meaningless rearrangement process can be prevented. Moreover, presenting the rearrangement process inhibition histories to the user can assist the user in making decisions on the computer system. As a result, the present embodiment can improve the performance of the entire computer system and the user friendliness.

Note that the present invention is not limited to the embodiment described above, and various changes can be made without departing from the scope of the invention.

For example, the present invention can be represented as an invention of a computer program as described hereinbelow.

“A computer program for causing a computer to manage a computer system including a host computer and a storage system,
wherein the storage system includes a virtual logical volume provided to the host computer, and a pool having a plurality of storage tiers, and executes a rearrangement process for associating a plurality of logical storage regions forming the virtual logical volume, with a storage region of any of the plurality of storage tiers based on an access frequency of the host computer to each of the logical storage regions, and
wherein the computer program causes the computer to execute:
a monitoring step of monitoring statuses of a plurality of predetermined resources that exist on a communication path between the host computer and the virtual logical volume and include the host computer and a controller of the storage system;
an availability determination step of determining to inhibit the execution of the rearrangement process on the virtual logical volume when the statuses of the plurality of predetermined resources monitored in the monitoring step satisfy a predetermined inhibition condition that is configured in advance; and
an instruction step of instructing the storage system on the execution of the rearrangement process based on the determination made in the availability determination step.”

### REFERENCE SIGNS LIST

10 Host computer

20 Switch

30 Storage system

31 Controller

40 Management computer

1. A management apparatus for managing a computer system including a host computer and a storage system,
wherein the storage system includes a virtual logical volume provided to the host computer, and a pool having a plurality of storage tiers, and executes a rearrangement process for associating a plurality of logical storage regions forming the virtual logical volume, with a storage region of any of the plurality of storage tiers based on an access frequency of the host computer to each of the logical storage regions, and
wherein the management apparatus comprises:
a resource monitoring part for monitoring a status of a resource related to the virtual logical volume; and
a rearrangement availability determination part for determining the availability of the execution of the rearrangement process on the virtual logical volume based on a monitoring result of the resource monitoring part.

2. The management apparatus of a computer system according to claim 1,
wherein the resource monitoring part monitors statuses of a plurality of predetermined resources that exist on a communication path between the host computer and the virtual logical volume and include the host computer and the storage system,
wherein the rearrangement availability determination part determines to inhibit the execution of the rearrangement process on the virtual logical volume when the statuses of the plurality of predetermined resources monitored by the resource monitoring part satisfy a predetermined inhibition condition that is configured in advance, and
wherein the management apparatus further comprises a rearrangement instruction part for instructing the storage system on the execution of the rearrangement process based on the determination made by the rearrangement availability determination part.

3. The management apparatus of a computer system according to claim 2, wherein the rearrangement availability determination part determines to inhibit the execution of the rearrangement process on the virtual logical volume when the status of any one of the plurality of predetermined resources satisfies a predetermined inhibition condition that is configured in advance for the predetermined resource.

4. The management apparatus of a computer system according to claim 3, wherein when the rearrangement availability determination part determines to inhibit the execution of the rearrangement process on the virtual logical volume, each of the logical storage regions of the virtual logical volume is prohibited from being rearranged in a storage tier higher than a current storage tier of the storage tiers.

5. The management apparatus of a computer system according to claim 4, wherein, even when the execution of the rearrangement process on the virtual logical volume is inhibited, the storage system can rearrange each of the logical storage regions in a storage tier lower than the current storage tier.

6. The management apparatus of a computer system according to claim 5, further comprising a warning part for outputting a warning screen to warn a user when the determination made by the rearrangement availability determination part regarding the inhibition of the execution of the rearrangement process satisfies a predetermined warning condition that is configured in advance.

7. The management apparatus of a computer system according to claim 6, further comprising a table for managing, as a history, information on the inhibition of the execution of the rearrangement process that is determined by the rearrangement process availability determination part,
wherein the warning screen can display information on all virtual logical volumes on which the execution of the rearrangement process is inhibited by the rearrangement availability determination part, within a period designated in advance.

8. The management apparatus of a computer system according to claim 7, further comprising an analysis result output part that analyzes a relationship between the predetermined resource satisfying the inhibition condition and the virtual logical volumes on which the execution of the rearrangement process is inhibited, and then outputs an analysis result screen showing a result of the analysis.

9. The management apparatus of a computer system according to claim 1, wherein, when a predetermined timing that is configured in advance comes, the rearrangement availability determination part determines the availability of the execution of the rearrangement process on the virtual logical volume, based on the monitoring result of the resource monitoring part.

10. The management apparatus of a computer system according to claim 1, wherein the predetermined timing is at least any of: a timing before the storage system executes the rearrangement process; a timing when a time designated by the user comes; and a timing when loads of the plurality of predetermined resources reach a monitoring start threshold value for start monitoring.

11. A method for managing a computer system including a host computer and a storage system, by using a management apparatus,
the storage system including a virtual logical volume provided to the host computer, and a pool having a plurality of storage tiers, and executes a rearrangement process for associating a plurality of logical storage regions forming the virtual logical volume, with a storage region of any of the plurality of storage tiers based on an access frequency of the host computer to each of the logical storage regions, and
the management method executing, by using the management apparatus:
a monitoring step of monitoring statuses of a plurality of predetermined resources that exist on a communication path between the host computer and the virtual logical volume and include the host computer and a controller of the storage system;
an availability determination step of determining to inhibit the execution of the rearrangement process on the virtual logical volume when the statuses of the plurality of predetermined resources monitored in the monitoring step satisfy a predetermined inhibition condition that is configured in advance; and
an instruction step of instructing the storage system on the execution of the rearrangement process based on the determination made in the availability determination step.

12. The management method of a computer system according to claim 11, wherein when the inhibition of the execution of the rearrangement process on the virtual logical volume is determined in the availability determination step, each of the logical storage regions of the virtual logical volume is prohibited from being rearranged in a storage tier higher than a current storage tier of the storage tiers.

13. The management method of a computer system according to claim 12, further comprising a warning step of outputting a warning screen to warn a user when the inhibition of the execution of the rearrangement process is determined in the availability determination step continuously a predetermined number of times that is configured in advance.
